(19) United States
(12) Patent Application Publication
(10) Pub. No.: US 2004/0045680 A1
(43) Pub. Date: Mar. 11, 2004

(54) Bead loosening device

(76) Inventors: Ronald Paul Kasner, Wadsworth, OH (US); Craig Cameron Ross, Stow, OH (US)

Correspondence Address: Cynthia S. Murphy, Nineteenth Floor, 1621 Euclid Avenue, Cleveland, OH, 44115-2191, US

(21) Appl. No.: 10/235,096

(22) Filed: Sep. 5, 2002

(51) Int. Cl. B60C 1/00

(52) U.S. Cl. 157/1

(57) ABSTRACT

A bead loosening device (10) can be used to loosen a tire from a rim while the tire/wheel assembly (20) is installed on a horizontal spindle (18) of a tire-testing machine (12). The device (10) comprises a supporting arm (30), having a first end pivotally connected to a lever (34), and a shoe-carrying arm (32), having a first end pivotally connected to the lever (34) and a second end to which a shoe (38) is attached. A handle (40) is connected to the lever (34) in such a manner that movement of the handle (40) results in the shoe (38) moving radially inward towards a sidewall of the tire. The shoe-carrying arm (32) follows a curved path slanted towards the supporting arm (30).

### FIELD OF THE INVENTION

The present invention relates generally as indicated to a bead loosening device and, more particularly, to a bead loosening device which can be used without removing the wheel from the tire testing machine.

### BACKGROUND OF THE INVENTION

A tire-testing machine is used to measure force variation or imbalance forces of a rotating tire/wheel assembly. A common type of this machine comprises a road wheel mounted on a horizontal shaft and a horizontal spindle on which the to-be-tested tire/wheel assembly is rotatably positioned. When the road wheel is rotated (e.g., the shaft is driven by a motor), the tire/wheel assembly is turned and appropriate measurements can be taken.

The uniformity of a wheel can be dependent upon the location of the tire relative to the rim of the wheel. For example, deviations in the rim can either cancel out or aggravate deviations in the tire depending upon their radial alignment with each other. Accordingly, a tire will be rotated relative to the rim between test runs to ensure that all alignment possibilities are being considered.

In the past, between-run rotations were performed by first removing the wheel from the horizontal spindle. The removed wheel is then carried to a work station, whereat it is placed on a vertical shaft and a bead-loosening device is used to loosen the tire from the rim's flange. After the bead is loosened, the tire can be rotated relative to the rim and then the bead can be replaced in the flange. The wheel is then carried back to the tire-testing machine and placed back on the horizontal spindle so that the next test run can be done.

### SUMMARY OF THE INVENTION

The present invention provides a bead loosening device which can be used without removing the wheel from the tire testing machine, so that between-run tire rotations can be performed more efficiently during testing procedures.

More particularly, the present invention provides a bead loosening device comprising a supporting arm having a first end pivotally connected to a lever, a shoe-carrying arm having a first end pivotally connected to the lever and a second end to which a shoe is attached, and a handle connected to the lever in such a manner that movement of the handle results in the shoe moving radially inward towards a sidewall of the tire. The shoe-carrying arm follows a curved path slanted towards the supporting arm. A ring can be attached to a second end of the supporting arm for engagement with a post. The shoe can comprise an arm-engaging wall attached to the second end of the shoe-carrying arm and a tire-engaging wall extending outwardly from a distal edge of the arm-engaging wall.

To loosen a tire from a rim while the tire/wheel assembly is installed on the tire-testing machine, the bead loosening device is positioned so that the shoe-carrying arm curves downwardly and the shoe is positioned adjacent a sidewall of the tire. The handle is then moved (e.g., pulled downwardly) so that the tire's sidewall is positioned inwardly by the shoe, and a bead of the tire is pushed out of engagement with the rim.

In a method of testing a tire according to the present invention, the to-be-tested tire/wheel assembly is placed on the horizontal spindle of the tire testing machine. The tire is then turned and appropriate measurements are taken. The bead loosening device is then used to remove the tire from the rim without removing the tire/wheel assembly from the spindle. The tire can then be rotated relative to the rim, and the rotated tire/wheel assembly can be turned so that a further set of test measurements can be taken.

The present invention provides these and other features hereinafter fully described and particularly pointed out in the claims. The following description and drawings set forth in detail a certain illustrative embodiment of the invention. This embodiment is indicative, however, of but one of the various ways in which the principles of the invention can be employed.

### DRAWINGS

FIG. 1 is a schematic view of a bead loosening device according to the present invention installed on a tire testing machine.

FIG. 2 is a perspective view of the bead loosening device.

FIG. 3 is a side sectional view showing the bead loosening device pushing a tire sidewall to loosen the tire from the rim.

### DETAILED DESCRIPTION

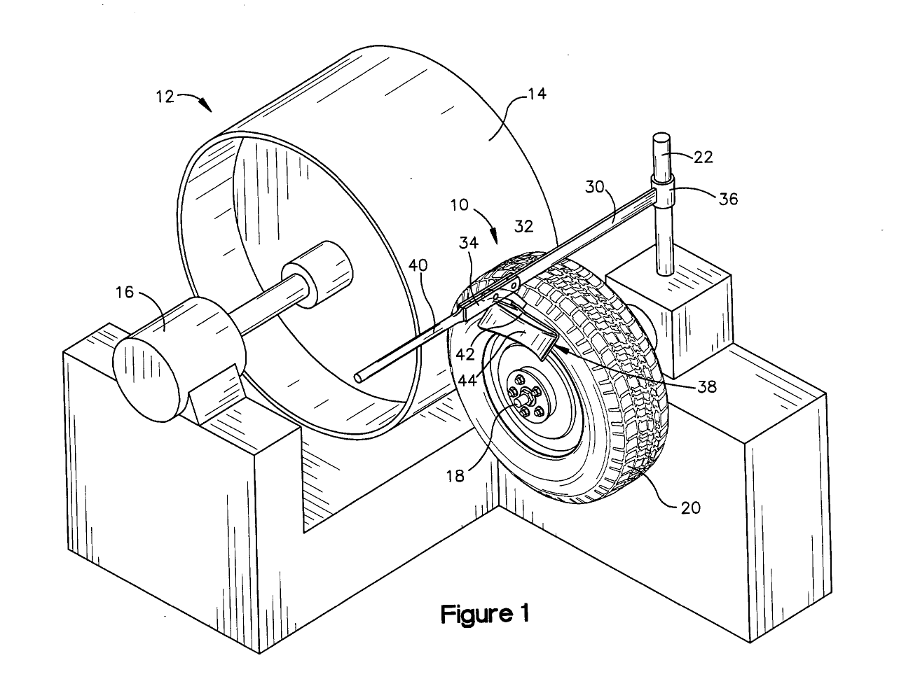

Referring now to the drawings and initially to FIG. 1, a bead loosening device 10 according to the present invention is shown installed on a tire testing machine 12. The machine 12 comprises a road wheel 14 mounted on a horizontal shaft 16 and a horizontal spindle 18 on which the to-be-tested tire/wheel assembly 20 is rotatably positioned. When the road wheel 14 is rotated (e.g., the shaft 16 is driven by a motor), the tire/wheel assembly 20 is turned and appropriate measurements can be taken. To accommodate mounting of the bead loosening device 10, a vertical post 22 is positioned behind the tire/wheel assembly 20 and suitably secured to the machine 12 or other appropriate surface.

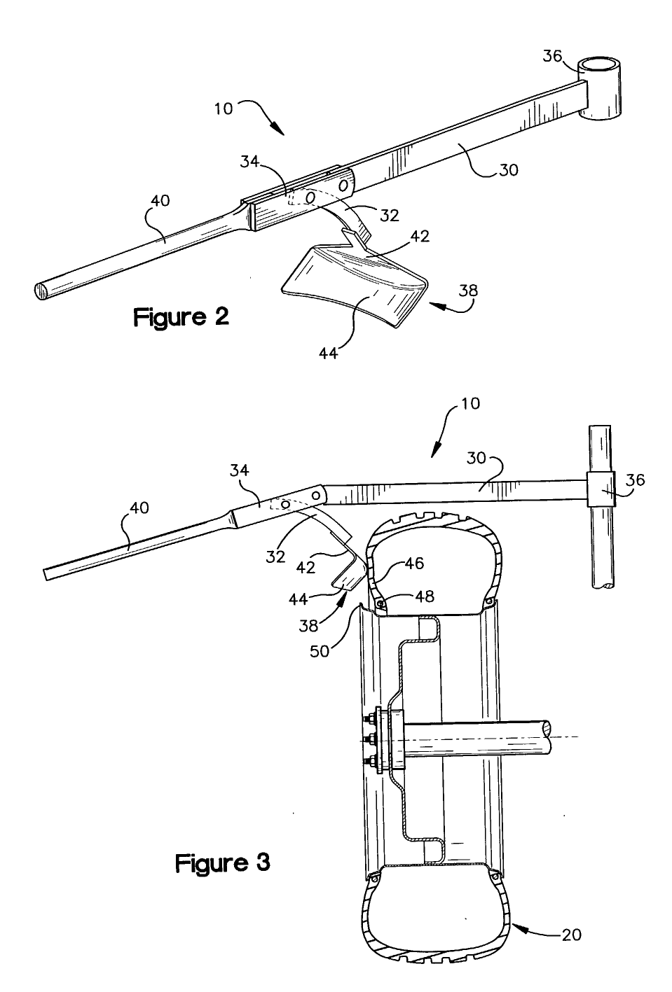

Referring now to FIG. 2, the bead loosening device 10 is shown isolated from the tire testing machine 12. The device 10 comprises a supporting arm 30 and a shoe-carrying arm 32, each having an end pivotally connected to a lever 34. In the illustrated embodiment, the supporting arm 30 is generally straight while the shoe-carrying arm 32 follows a curved path slanted in the direction of the supporting arm 30.

A bearing ring 36 is attached to the distal end of the arm 30, a shoe 38 is attached to the distal end of the arm 32, and a handle 40 is attached to the lever 34. The shoe 38 comprises a fan-shaped wall 42 which follows the curve of the arm 32 and a tire-engaging wall 44 extending outwardly from the distal edge of the wall 42. The wall 44 has a roughly bow-tie shape which is bent to follow the curve of the distal edge of the fan-shaped wall 42. The distal edge of the wall 44 has a curve which corresponds to the rim of the tire/wheel assembly.

In the starting position, the bearing ring 36 is received over the vertical post 22 so that the shoe-carrying arm 38 curves downwardly towards the post 22 and the shoe's tire-engaging wall 44 is positioned adjacent the tire side wall 46 along the upper edge of the wheel rim. (FIG. 1.) In the illustrated embodiment, the support arm 30 extends substantially horizontally from the post 22 to the lever 34 and the handle 40 extends substantially horizontally from the lever 34. On downward (manual) movement of the handle 40, the tire sidewall 46 is pushed inwardly by the shoe's wall 44 and the tire bead 48 is rolled out of engagement with its complementary rim portion (e.g., flange) 50. (FIG. 3.)

In a method of testing a tire according to the present invention, the to-be-tested tire/wheel assembly 20 is placed on the horizontal spindle of the tire testing machine 12. The road wheel 14 is rotated (e.g., the shaft 16 is driven by a motor), whereby the tire/wheel assembly 20 is turned and appropriate measurements can be taken. The bead-loosening device 10 is then used to loosen the tire from the rim's bead-engaging flange without removing the tire/wheel assembly 20 from the machine 12. After the bead is loosened, the tire can be rotated relative to the rim and then the bead can be replaced in the flange. The road wheel 14 is then again rotated to turn the tire/wheel assembly 16 so that appropriate test measurements can be taken.

It may be noted that the bead-loosening device 10 of the present invention can be constructed from a bead-loosening device conventionally used to loosen the bead at a work station. At such a work station, the removed-from-the-machine tire is placed on a vertical shaft and the conventional bead-loosening device is used to loosen the tire from the rim's flange. The bead-loosening device 10 can be constructed by lengthening the conventional supporting arm and/or the conventional shoe-carrying arm, and by repositioning the conventional shoe-carrying arm so that it curves towards the distal end of the supporting arm.

Although the invention has been shown and described with respect to a certain embodiment, it is obvious that equivalent alterations and modifications will occur to others skilled in the art upon the reading and understanding of this specification. The present invention includes all such alterations and modifications and moreover is limited only by the scope of the following claims.

1. A bead loosening device that can be used to loosen a tire from a rim while the tire and rim are installed on a vertical spindle of a tire-testing machine, said device comprising:
a supporting arm having a first end pivotally connected to a lever;
a shoe-carrying arm having a first end pivotally connected to the lever and a second end to which a shoe is attached; and
a handle connected to the lever in such a manner that movement of the handle results in the shoe moving radially inward towards a sidewall of the tire; and
wherein the shoe-carrying arm follows a curved path slanted towards the supporting arm.

2. A bead loosening device as set forth in claim 1, wherein the supporting arm has a second end to which a ring is attached for engagement with a post.

3. A bead loosening device as set forth in claim 2, wherein the shoe comprises an arm-engaging wall attached to the second end of the shoe-carrying arm and a tire-engaging wall extending outwardly from a distal edge of the arm-engaging wall.

4. A bead loosening device as set forth in claim 1, wherein the shoe comprises an arm-engaging wall attached to the second end of the shoe-carrying arm and a tire-engaging wall extending outwardly from a distal edge of the arm-engaging wall.

5. A bead loosening device as set forth in claim 4, wherein the arm-engaging wall is fan-shaped and follows the curved path of the shoe-carrying arm.

6. A bead loosening device as set forth in claim 5, wherein the tire-engaging wall is bent to follow a curved distal edge of the fan-shaped wall and wherein a distal edge of the tire-engaging wall has a curve which corresponds to the rim of the tire/wheel assembly.

7. A bead loosening device as set forth in claim 4, wherein the tire-engaging wall is bent to follow a curved distal edge of the fan-shaped wall and wherein a distal edge of the tire-engaging wall has a curve which corresponds to the rim of the tire/wheel assembly.

8. A method of loosening a tire from a rim while the tire and rim are installed on a substantially horizontal spindle of a tire-testing machine, said method comprising the steps of:
positioning the bead loosening device of claim 1 so that the shoe-carrying arm curves downwardly and the shoe is positioned adjacent a sidewall of the tire; and
moving the handle so that the tire's sidewall is positioned inwardly by the shoe and a bead of the tire is pushed out of engagement with the rim.

9. A method as set forth in claim 8, wherein said moving step comprises downwardly moving the handle.

10. A method of loosening a tire from a rim while the tire and rim are installed on a substantially horizontal spindle of a tire-testing machine, said method comprising the steps of:
placing the ring of the bead loosening device of claim 2 around a vertical post appropriately positioned adjacent the installed tire;
positioning the bead loosening device so that the shoe-carrying arm curves downwardly and the shoe is positioned adjacent a sidewall of the tire; and
moving the handle so that the tire's sidewall is positioned inwardly by the shoe and a bead of the tire is pushed out of engagement with the rim.

11. A method as set forth in claim 10, wherein said moving step comprises downwardly moving the handle.

12. A method of loosening a tire from a rim while the tire and rim are installed on a substantially horizontal spindle of a tire-testing machine, said method comprising the steps of:
positioning the bead loosening device of claim 4 so that the shoe-carrying arm curves downwardly and the shoe's tire-engaging wall is positioned adjacent a sidewall of the tire; and
moving the handle so that the tire's sidewall is pushed inwardly by the tire-engaging wall and a bead of the tire is pushed out of engagement with the rim.

13. A method as set forth in claim 12, wherein said moving step comprises downwardly moving the handle.

14. A method as set forth in claim 13, wherein the arm-engaging wall is fan-shaped and follows the curved path of the shoe-carrying arm.

15. A method as set forth in claim 14, wherein the tire-engaging wall is bent to follow a curved distal edge of the fan-shaped wall and wherein a distal edge of the tire-engaging wall has a curve which corresponds to the rim of the tire/wheel assembly.

16. A method as set forth in claim 13, wherein the tire-engaging wall is bent to follow a curved distal edge of the fan-shaped wall, and wherein a distal edge of the tire-engaging wall has a curve which corresponds to the rim of the tire/wheel assembly.

17. A method of testing a tire, comprising the steps of:
placing a to-be-tested tire/wheel assembly on a horizontal spindle of a tire testing machine,
turning the tire/wheel assembly and taking appropriate measurements,
using the bead-loosening device of claim 1 to loosen the tire from the rim without removing the tire/wheel assembly from the spindle,
rotating the tire relative to the rim, and
turning the rotated tire/wheel assembly and taking appropriate measurements.

18. In combination, the bead-loosening device of claim 1, a tire/wheel assembly, and a tire testing machine, said tire testing machine comprising a road wheel mounted on a horizontal shaft and a horizontal spindle on which the tire/wheel assembly is installed.
